(19) United States
(12) Patent Application Publication
(10) Pub. No.: US 2016/0247186 A1
(43) Pub. Date: Aug. 25, 2016

(54) NETWORK DIFFUSION CONVERGENCE AND DIVERGENCE ANALYSIS SYSTEM

(71) Applicant: Bank of America Corporation, Charlotte, NC (US)

(72) Inventors: Robert L. Abbott, Charlotte, NC (US); Jason P. Blackhurst, Charlotte, NC (US); Alfred Hamilton, Charlotte, NC (US); Frederick A. Shahda, Charlotte, NC (US)

(21) Appl. No.: 14/626,725

(22) Filed: Feb. 19, 2015

(51) Int. Cl. G06Q 30/02

(52) U.S. Cl. CPC G06Q 30/0244; G06Q 30/0269

(57) ABSTRACT

Embodiments of the invention are directed to a system, method, or computer program product for providing network diffusion convergence and divergence analysis. Thus identifying the convergence of a network diffusion model and subsequent divergence of the diffusion back to normal spend standards. The invention creates a repository of spend data for a period of time and for a specific category of purchases. Using geospatial information identifies a group within the repository and an influencer based on an inferred relationship and degree influence. In this way, the invention provides a means of delivering to the influencer for diffusion throughout a group of individuals. The system subsequent tracks the duration of convergence, initial divergence, and complete divergence. This data is then utilized to determine influencer and indirect delivery effectiveness.

### BACKGROUND

Advancements in internet technology, social media, and the like allow for a multitude of options for advertisers to advertise products and services. Furthermore, advertisers can reach a broader customer base than ever before. With these additional advertisement outlets, merchants may be able to invest more and more assets into advertising. However, while these advancement allow for a broader customer base to potentially be reached, it becomes difficult to target and track the effectiveness of any one advertisement campaign and an appropriate duration of effectiveness of the campaign.

### BRIEF SUMMARY

Embodiments of the present invention address the above needs and/or achieve other advantages by providing apparatuses (e.g., a system, computer program product and/or other devices) and methods to provide network diffusion convergence and divergence analysis systems for advertisement presentation and effectiveness. In this way, the system modifies a computer system in order to provide a distributive network with unique network data feeds that transform data provided to utilize network diffusion for advertisement effectiveness and subsequent predictive analysis of convergence and/or divergence of the effectiveness. Initially, it is acknowledged that advertisement effectiveness may not be based on a customer visualizing the advertisement, but instead because of an advertisement or offer being presented to a single customer or influencer that may diffuse the advertisement or offer data across a group based on the influencer's node or influence rank. In this way, the group of individuals may be more receptive to a product based on the influencer as opposed to the group receiving an offer for the product directly. In this way, the invention provides a means of delivering advertisements or offers to appropriate influencers for diffusion throughout a group of individuals. In this way, it is appreciated that there may be a greater advertisement value to present the advertisement or offers only to the influencer than presenting the advertisement or offers to everyone in a determined group associated with the influencer.

Furthermore, the system identifies and determines the convergence and subsequent divergence of the influence of the influencer with respect to a group. In this way, once the influencer or, in some embodiments, a zero degree (0°), first degree (1°), or second degree (2°) individual, is provided an offer, the system determines a convergence of purchase behavior among the group surrounding the influencer based on the change in purchase habits of the influencer because of the offer. As such, an advertisement or offer may be presented to the influencer, that offer may change the purchase habits of the influencer, such that the influencer may purchase a product of the offer or advertisement. Subsequently, there will be a convergence of purchase behavioral changes to the group influenced by the influencer. This convergence among the group will converge the purchase behavior of the group to a similar behavior as the influencer who received the offer. As such, the convergence may be such that the group may now also purchase the product of the offer or advertisement.

However, at some point the influence of the influencer will slowly wear off of the group. At that point, the group may return to their original purchase behavior. The divergence of influence back the groups original behavior may occur at various durations based on the influencer's influence on the group. As such, as stronger influencer will provide convergent purchase behavior of a group for a longer time than a weaker influence.

In some embodiments, the invention may create a repository of customer spending data for a period of time and for a specific category of purchases. As such, for the time period and category of purchases, the system may identify a network of customers that correspond to the time period and category. The network may include more than one individual linked together based on similar transaction history, coincided mapping, or social networking. As such, a network of customers may be a group of individuals that are linked in some way, such that the network may all be interested in one or more of the same or similar products and services, and the advertisements associated with the products and services. In some embodiments, the network of customers may comprise one or more individuals that know each other. In other embodiments, the network of customers may not know each other. The network of customers may comprise more than one customer. The influencer being identified as the customer that may directly or indirectly influence the other individuals within the network or group with respect to purchasing products and/or services within a category. The group being identified as one or more customers that are directly or indirectly influenced by the influencer. In some embodiments, there may be one influencer in each network. In other embodiments, there may be more than one influencer in each network. In some embodiments, an individual may be an influencer for one category of products within a network, but be part of a group for another category of products within the network.

Once a group of customers and the purchase behavior of the group has been identified, an analysis of the group can be performed to identify and infer relationships among the members of the group. This allows the system to determine one or more customers within the group as key influencers of the population. The key influencers are ranked based on influence for a duration of time and category of product and given a degree level based on the influence duration for that particular category. The degree level ranges from a 0 degree, or highest influencer, 1 degree, 2 degree, 3 degree, and the like descending in rank according to the number of individuals within the group that the influencer influences. In this way, the system may identify influencers and categories of products or time frames that that particular influencer may be more influential to the group. For example, an individual identified as an influencer within a group for a particular category may be extremely influential for products associated with that category. For example, an influencer may be identified as having knowledge and influence among a group for electronic products. In this way, the influencer may have knowledge of electronics and be in a position within a group to influence the purchase of electronic equipment among the other individuals within the group. However, the influencer may not be influential for products in another category within the group. Members of the group that have no determined sphere of influence are simply followers and appear as terminal nodes in the network or group. For any given product category there may be one or more similarly positioned influencers, these influencers may be positioned into a group or cohort.

In some embodiments, the system may then develop a specific plan to optimally implement a product marketing campaign for that cohort of influencers. This plan may include additional offers, such as larger discounts, promotions, or the like for products or particular targeted advertisement to the cohort for a particular product or category of products. The plan identifies advertisements or options with potential greater value for indirect presentation and based on the identified influencers, the invention continues by matching the advertisements with influencers that are influential in one or more categories. The categories include categories of products or services, such as sporting goods, electronics, clothing, automotive, home, garden, and the like.

Once the plan is implemented, the system identifies and determines the convergence and subsequent divergence of the influence of the influencer with respect to a group. In this way, once the influencer or, in some embodiments, a zero degree (0°), first degree) (1°, or second degree (2°) individual, is provided an offer, the system determines a convergence of purchase behavior among the group surrounding the influencer based on the change in purchase habits of the influencer because of the offer, which is identified as the convergence of the groups habits to the influencer's based on the plan. Subsequently, at some point, the convergence will eventually diverge back to an original purchase behavior for the group. As such, at some point the influence of the influencer will slowly wear off of the group. At that point, the group may return to their original purchase behavior. The divergence of influence back the group's original behavior may occur at various durations based on the influencer's influence on the group. As such, as stronger influencer will provide convergent purchase behavior of a group for a longer time than a weaker influence.

After the plan has been implemented and an influencer has been presented an advertisement or offer, the invention continues by monitoring transaction data associated with the influencer and the group associated with the influencer to identify convergence of the purchase habits of the group to the influencer. The system may receive subsequent customer financial transactions for transactions associated with merchants, products, and/or services of the advertisements for either the influencer or the group associated with the influencer. The invention may match the products of the transaction to products presented to the influencer and create feedback in the form of marketing effectiveness data to one or more advertisers. Furthermore, the system may continue to monitor transaction history to determine a time frame of convergence and subsequent dilution of the influence and divergence of the purchase habits of the group back away from the influencer's habits back to the groups purchase habits prior to the influence.

Embodiments of the invention relate to systems, methods, and computer program products for convergence and divergence analysis, including a distributive network for the convergence and divergence analysis that comprises: creating a repository of spend data for a predetermined period of time and for a specific product category; identify, using network data feeds from the distributive network, a group of individuals within the repository, wherein the group is identified based on each member of the group purchasing a product within the specific product category, within the predetermined period of time, and based on geospatial recognition; inference mapping for identification of influencers among the group for the specific product category; transforming inference mapping data into degree ranking for influencer; providing an offer to the influencer for a product within the specific product category, wherein the offer value is based on the degree ranking of the influencer; identifying convergence of group spend data converging to influencer spend data based on the offer; tracking and identifying divergence of group spend based on the convergence and record time data associated with divergence; and transforming convergence data, divergence data, and recorded time data associated with divergence to advertisement diffusion feedback and influencer degree adjustments, whereby providing advertisement and offer effectiveness for the product category.

In some embodiments, identifying the group of individuals within the repository comprises using geographic location determination in connection with transaction history, coincident mapping, or social network mapping to identify the group of individuals geospatially located and associated with the specific product category, wherein transaction history identifies similar transactions for the specific product category, coincided mapping maps likely association of individuals based on the specific category of products, and social networking mapping identifies a network of individuals associated with each other.

In some embodiments, inference mapping for identification of influencers among the group for the specific product category further comprises inference mapping based on social network and geospatial data to identify and build degrees of influence among group individuals.

In some embodiments, identifying convergence of group spend data further comprises identifying when one or more individuals in the group purchase one or more products in the specific category of products that the influencer has purchased based on the offer

In some embodiments, identifying convergence of group spend data further comprises tracking a duration of time associated with the convergence of group spend data.

In some embodiments, identifying divergence of group spend data further comprises determining an initial time point when one or more individuals of the group initially diverge in spend trends from the influencer back to the one or more individuals spend trend prior to being influenced.

In some embodiment, transforming convergence data, divergence data, and recorded time data associated with divergence further comprises calculating an influence rate of the influencer based on the transform convergence data, divergence data, and recorded time data associated with divergence to adjust influencer degree for future groups and product categories.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating network diffusion convergence and divergence, in accordance with one embodiment of the present invention;

FIG. 2 provides a network diffusion system environment, in accordance with one embodiment of the present invention;

FIG. 3 provides a process map illustrating a process of identifying a group and an influencer associated with the group, in accordance with one embodiment of the present invention;

FIG. 4 provides a process map illustrating means of inferring a group and influencers within the group for a product category, in accordance with one embodiment of the present invention;

FIG. 5 provides a process map illustrating social network diffusion, in accordance with one embodiment of the present invention; and

FIG. 6 provides a process map illustrating convergence and divergence of spend based on influencer degree, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that may provide payment accounts for transactions.

Some portions of this disclosure are written in terms of a financial institution's unique position with respect to customer transactions. As such, a financial institution may be able to utilize its unique position to monitor and identify transactions for products or with merchants that utilize financial institution accounts to complete the transactions.

The embodiments described herein may refer to the initiation and completion of a transaction. Unless specifically limited by the context, a “transaction”, “transaction event” or “point of transaction event” refers to any customer completing or initiating a purchase for a product, service, or the like. The embodiments described herein may refer to an “advertisement.” An advertisement, as used herein may include one or more of a deal, offer, coupon, promotion, incentive, commercial, advertisement, or the like. The advertisement may be for a product, service, merchant, merchant, brand, or the like. Furthermore, the term “product” as used herein may refer to any product, service, good, or the like that may be purchased through a transaction.

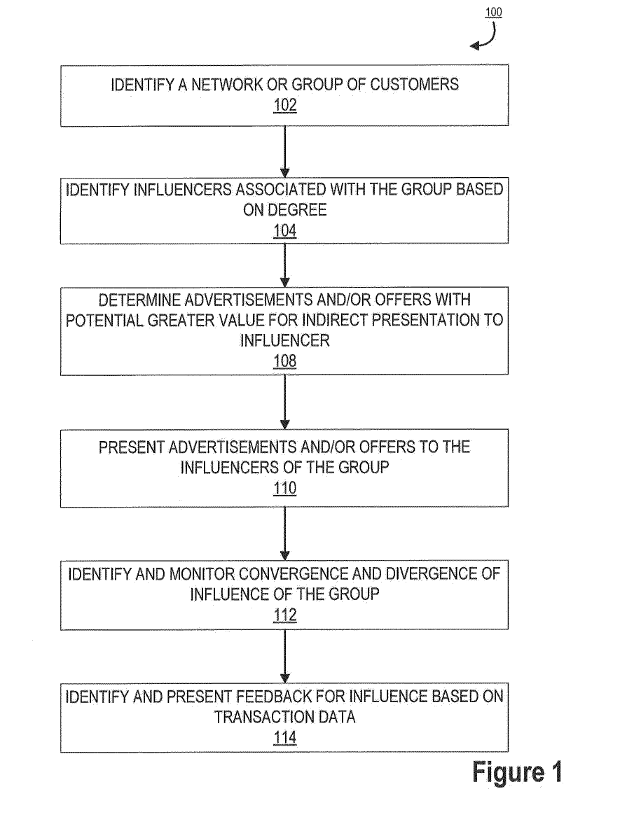

FIG. 1 provides a high level process flow illustrating network diffusion convergence and divergence 100, in accordance with one embodiment of the present invention. The process 100 is initiated by identifying a network or group of customers 102. The network may include more than one individual linked together based on similar transaction history for a giving product category within a specified time period. As such, a network of customers may be a group of individuals that are linked in some way, such that the network may all be interested in one or more of the same or similar products and services. In some embodiments, the network of customers may comprise one or more individuals that know each other. In other embodiments, the network of customers may not know each other. The network of customers may comprise more than one customer.

Next, as illustrated in block 104, the process 100 continues by identifying influencers associated with the network or group and determine a degree of influence for that influencer with respect to the time and product category. The influencer being identified as the customer that may directly or indirectly influence the other individuals within the network with respect to purchasing products and/or services within a category. In some embodiments, there may be one influencer in each network. In other embodiments, there may be more than one influencer in each network. In some embodiments, an individual may be an influencer for one category of products within a network, but be part of a group for another category of products within the network. Identifying the influencers further includes performing an analysis of the group to identify and infer relationships among the members of the group. This allows the system to determine one or more customers within the group as key influencers of the population. The key influencers are ranked based on influence for a duration of time and category of product and given a degree level based on the influence duration for that particular category. The degree level ranges from a 0 degree, or highest influencer, 1 degree, 2 degree, 3 degree, and the like descending in rank according to the number of individuals within the group that the influencer influences. In this way, the system may identify influencers and categories of products or time frames that that particular influencer may be more influential to the group.

As illustrated in block 108, the process 100 continues, once the group and influencers for that group have been identified, the system identifies advertisements and/or offers that have potentially greater value for indirect presentation to the influencer for the entire group. In this way, the system may identify one or more advertisements or offers that may be more influential if they are provided indirectly to a customer of the group. In this way, the system may identify influencers and categories of products that that particular influencer may be more influential to the group.

Next, as illustrated in block 110, the process 100 continues by presenting advertisements and/or offers to the influencers. These advertisements will be presented to the influencers in hopes that the influencer will disseminate the information associated with the advertisements or offers to a group surrounding the influencer. Furthermore, the presentation to the influencer can be time and/or location based. In this way, the system may identify a time or location for presentation of the advertisement to provide greater value for the advertisement to the influencer to diffuse through to the group. In some embodiments, the offer provided to influencers with a higher degree of influence may be greater than the offers provided to influencers with a lower degree of influence.

Next, as illustrated in block 112, the process 100 continues by identifying and monitoring the convergence and divergence of purchase habits among the group based on the influencer. As such, after an advertisement or offer has been presented to the influencer, that offer may change the purchase habits of the influencer, such that the influencer may purchase a product of the offer or advertisement. Subsequently, there will be a convergence of purchase behavioral changes to the group influenced by the influencer. This convergence among the group will converge the purchase behavior of the group to a similar behavior as the influencer who received the offer. As such, the convergence may be such that the group may now also purchase the product of the offer or advertisement.

Finally, as illustrated in block 114, the process 100 concludes by identifying and presenting feedback for the indirect group advertisement based on transaction data for the group and influencer, as well as the time duration of the convergence and divergence. In this way, data is collected as to how long the influencer influenced the convergence of the purchase habits of the group and subsequently how long it took for the purchase habits to diverge away from the influencer.

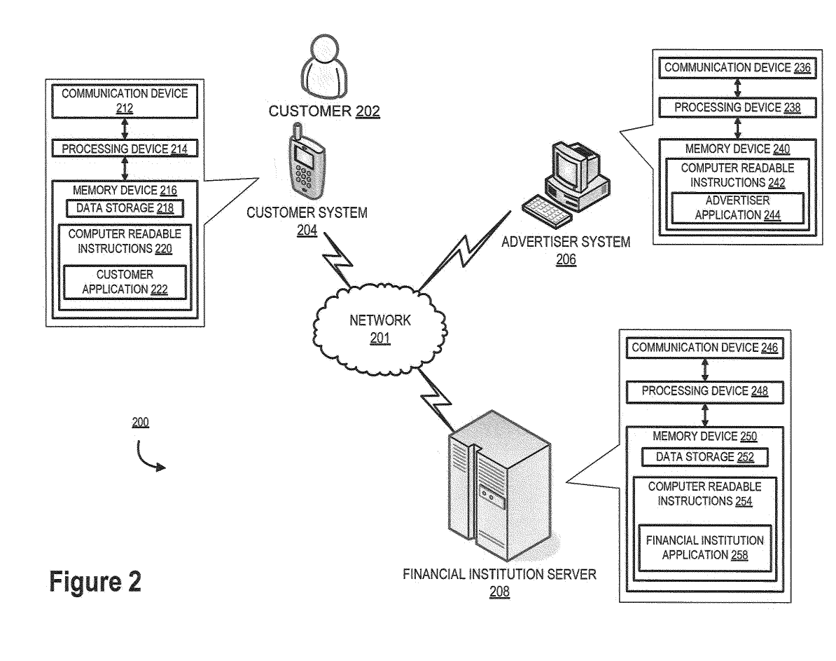

FIG. 2 provides a network diffusion system environment 200, in accordance with one embodiment of the present invention. As illustrated in FIG. 2, the financial institution server 208 is operatively coupled, via a network 201 to the customer system 204, and to the advertiser system 206. In this way, the financial institution server 208 can send information to and receive information from the customer system 204 and the advertiser system 206 to provide network diffusion for advertisement presentment and impressions. FIG. 2 illustrates only one example of an embodiment of an advertisement network diffusion system environment 200, and it will be appreciated that in other embodiments one or more of the systems, devices, or servers may be combined into a single system, device, or server, or be made up of multiple systems, devices, or servers.

The network diffusion system environment 200 is a unique system that includes specialized servers and system communicably linked across a distributive network of node required to provide network diffusion convergence and divergence determination of influencers, providing of offers and analysis of the same. The system, with its communicably linked diffusible network may, in some embodiments, improve a general computing device if utilized thereon by improving the ability for the computer device to access and process network diffusion convergence and divergence analysis. Furthermore, in some embodiments, the system may be, as described below, run on a diffusion network of specialized nodes meant for determining network diffusion calculations, influencers, and providing convergence and divergence analysis.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the customer 202 is an individual associated with a network or group. In some embodiments, the individual may be someone with influence over the other individuals associated with the network for a product purchase. In some embodiments, the individual may be influenced by one or more individuals in the network with respect to a product purchase. The customer 202 may view an advertisement either directly or indirectly and/or receive an offer based on his/her influential status. Subsequently, in some embodiments, the customer 202 may purchase a product using a customer system 204. In some embodiments, the customer 202 may be a merchant or a person, employee, agent, associate, independent contractor, and the like that has an account or business with a financial institution or another financial institution that may provide payment to complete a transaction.

FIG. 2 also illustrates a customer system 204. The customer system 204 generally comprises a communication device 212, a processing device 214, and a memory device 216. The customer system 204 is a computing system that allows a customer 202 to interact with the financial institution and other systems on the advertisement network diffusion system environment 200. In this way, a customer 202 may, via the customer system 204, interact with a network or group via social media, and/or set up payment or transaction accounts to complete transactions for products and/or services of advertisements. The processing device 214 is operatively coupled to the communication device 212 and the memory device 216. The processing device 214 uses the communication device 212 to communicate with the network 201 and other devices on the network 201, such as, but not limited to the advertiser system 206 and the financial institution server 208. As such, the communication device 212 generally comprises a modem, server, or other device for communicating with other devices on the network 201.

The customer system 204 comprises computer-readable instructions 220 and data storage 218 stored in the memory device 216, which in one embodiment includes the computer-readable instructions 220 of a customer application 222. In this way, a customer 202 may interact with a group or network of individuals via the network 201, open a financial institution account, remotely communicate with the financial institution, authorize and complete a transaction, or complete a transaction using the customer's customer system 204. The customer system 204 may be, for example, a desktop personal computer, a mobile system, such as a cellular phone, smart phone, personal data assistant (PDA), laptop, or the like. Although only a single customer system 204 is depicted in FIG. 2, the system environment 200 may contain numerous customer systems 204.

As further illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the advertiser system 206 and the customer system 204. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of a financial institution application 258. In some embodiments, the memory device 250 includes data storage 252 for storing data related to network diffusion advertisement presentment, but not limited to data created and/or used by the financial institution application 258.

In the embodiment illustrated in FIG. 2 and described throughout much of this specification, the financial institution application 258 may identify an influencer and a group for a time period and product category, identify influencers influence ability and degree of influence, receive advertisements and offers within the product category with potential value for indirect presentation, match advertisements and offers to influencers, present matched advertisements and offers to the influencer, and track financial data of influencers and groups for convergence and divergence of purchase habits based on influencer.

In some embodiments, the financial institution application 258 may identify an influencer and group for a time period and product category. In this way, the group and influencers may be identified based on a time period and category of purchase. For example, there may be a predetermined time period where the financial institution application 258 may identify customers that purchased products in a category within that time period. In some embodiments, the financial institution application 258 may create a repository of customer spending data for a period of time and for a specific category of purchases. As such, for the time period and category of purchases, the financial institution application 258 may identify a network of customers that correspond to the time period and category of product. The group may include more than one individual linked together based on similar transaction history within a time period for a particular product category, coincided mapping, or social networking. As such, a group of customers may be a group of individuals that are linked in some way, such that the group may all be interested in one or more of the same or similar products and services within a category. Categories may include product categories, such as electronics, clothing, sporting goods, or the like. Categories may also include service categories such as home services, financial services, or the like. In some embodiments, the group of customers may comprise one or more individuals that know each other. In other embodiments, the group of customers may not know each other.

The influencer being identified as the customer that may directly or indirectly influence the other individuals within the network or group with respect to purchasing products and/or services within a category. The group being identified as one or more customers that are directly or indirectly influenced by the influencer. In some embodiments, there may be one influencer in each group. In other embodiments, there may be more than one influencer in each group. In some embodiments, an individual may be an influencer for one category of products within a network, but be part of a group for another category of products within the network.

In some embodiments, the financial institution application 258 may further identify influencers influence ability and degree of influence of the influencer. Once a group of customers and the purchase behavior of the group has been identified, an analysis of the group can be performed to identify and infer relationships among the members of the group. This allows the financial institution application 258 to determine one or more customers within the group as key influencers of the population. The key influencers are ranked based on influence for a duration of time and category of product and given a degree level based on the influence duration for that particular category. The degree level ranges from a 0 degree, or highest influencer, 1 degree, 2 degree, 3 degree, and the like descending in rank according to the number of individuals within the group that the influencer influences. In this way, the financial institution application 258 may identify influencers and categories of products or time frames that that particular influencer may be more influential to the group. The influencers are ranked and accorded a degree based on potential influence of a group of individuals. The influencer is identified based on first identifying a product category and a time frame. Once the group that purchased products within the category and time frame are identified, the financial institution application 258 identifies a geospatial network of the group. Within the geospatial network of the group, the financial institution application 258 may determine one or more influencers within the population. These influencers are based on a connection that the influencer has to the other individuals of the group. The connections or nodes associated with the group are aggregated based on degree. The degree level ranges from a 0 degree, or highest influencer, 1 degree, 2 degree, 3 degree, and the like descending in rank according to the number of individuals within the group that the influencer influences. The inferred relationships between the individuals of the group build the degree level of the influencer. The more inferred relationships built, the more influential the individual may be and the lower degree level assigned to that individual. Relationship inference may be based on social network association, location association, employment association, network association, or the like. As such, the financial institution application 258 identifies individuals that may have influenced others around him/her to purchase similar products in the category. For example, a neighbor may influence furniture purchases, automobile purchases or the like, a public figure may influence a clothing or brand purchase, or the like. Members of the group that have no determined sphere of influence are simply followers and appear as terminal nodes in the network or group. In some embodiments, the influencer's influence may be based on category of product. In this way, the financial institution application 258 may identify influencers and categories of products that that particular influencer may be more influential to the group. For example, an individual identified as an influencer within a group for a particular category may be extremely influential for products associated with that category. For example, an influencer may be identified as having knowledge and influence among a group for electronic products. In this way, the influencer may have knowledge of electronics and be in a position within a group to influence the purchase of electronic equipment among the other individuals within the group. However, the influencer may not be influential for products in another category within the group. In some embodiments, the influence ability of the influencer may be on the influencer's status and/or the number of individuals in a group. In some embodiments, an influencer's influence status may make him/her more likely to influence the members of the group for advertisement diffusion purposes. The influence status may increase if the influencer is a celebrity or it is determined that the influencer has significant influence over group members. In some embodiments, the number of individuals in the influencer's group may affect the influencers influence ability with respect to the group. The more individuals identified within the group, the more possibility for influence by the influencer in these circumstances.

For any given product category there may be one or more similarly positioned influencers, these influencers may be positioned into a group or cohort. The financial institution application 258 will identify influencers that may diffuse ideas, concepts, and product advertisements or offers throughout a group based on his/her position as influencer within the network for that one or more product categories. The influencer being identified as the customer 202 that may directly or indirectly influence the other individuals within the network with respect to purchasing products and/or services within a category. The financial institution application 258 may also identify groups of customers 202 around the influencer. The customers 202 in the group may be one or more individuals identified to receive and accept recommendations from an influencer for a particular product or category of products. In this way, the group consists of one or more customers 202 that are directly or indirectly influenced by the influencer.

In some embodiments, the financial institution application 258 may receive advertisements and offers within the product category with potential value for the influencer to receive and disseminate among the group. In this way, the financial institution application 258 may receive, from the advertisement system 206, one or more advertisements or offers with potential value for indirect presentation. In some embodiments, the financial institution application 258 may determine the advertisements or offers with potential value for indirect presentation. The advertisements or offers for products with potential value for indirect presentation may be determined based on market research, product data, advertiser data, or the like associated with the product category. In this way, the advertisement system 206 may identify one or more advertisements or offers that may be more influential if they are provided indirectly to a customer 202. In some embodiments, this identification may be based on the advertisement contents or offer amount.

In some embodiments, the financial institution application 258 may match advertisements and offers to influencers. In this way, the financial institution application 258 may match the advertisements and offers determined to have a potential value for indirect presentment with the appropriate influencers. The match is based on the identified advertisements with potential value for indirect presentation, the identified influencer, and the category of product identified for that influencer and group. The categories include categories of products or services, such as sporting goods, electronics, clothing, automotive, home, garden, and the like.

In some embodiments, the financial institution application 258 may present matched advertisements and offers to the influencer. In some embodiments, the financial institution application 258 may present the matched advertisements and/or offers directly to the influencer for the group. The value of the offer may be directly correlated to the degree influence the influencer is determined to have. A zero degree influencer will typically receive a more valuable offer or advertisement than a first, second, third, or fourth degree influencer.

In some embodiments, the financial institution application 258 may track financial data of influencers and groups for convergence and divergence of purchase habits based on the influencer, to provide feedback for the indirect group advertisement. In this way, the financial institution application 258 may monitor transaction data for the group and the influencer after the advertisement or offer has been presented to the influencer. In this way, after the advertisement has been presented to the influencer, the financial institution application 258 continues by monitoring transaction data associated with the influencer and the group associated with the influencer. The financial institution application 258 may receive subsequent customer 202 financial transactions for transactions associated with merchants, products, and/or services of the advertisements for either the influencer or the group associated with the influencer. The financial institution application 258 may match the products of the transaction to products presented to the influencer and create feedback in the form of marketing effectiveness data to one or more advertisers. In this way, the financial institution application 258 may compile convergence data associated with the convergence of the groups spend data to that of the influencer and infer that the convergence is based on the presented offer or advertisement. However, at some point the influence of the influencer will slowly wear off of the group. At that point, the group may return to their original purchase behavior. The divergence of influence back the groups' original behavior may occur at various durations based on the influencer's influence on the group. As such, as stronger influencer will provide convergent purchase behavior of a group for a longer time than a weaker influence. As such, the financial institution application 258 may track the time it takes for the group to converge to the influencer's purchase habits, the duration of the convergence, and when the group diverges from the influencer's purchase habit.

As illustrated in FIG. 2, the advertiser system 206 is connected to the financial institution server 208 and is associated with the entity providing the advertisements or offers. In this way, while only one advertiser system 206 is illustrated in FIG. 2, it is understood that multiple advertiser systems may make up the system environment 200. The advertiser system 206 generally comprises a communication device 236, a processing device 238, and a memory device 240. The advertiser system 206 comprises computer-readable instructions 242 stored in the memory device 240, which in one embodiment includes the computer-readable instructions 242 of an advertiser application 244.

In the embodiment illustrated in FIG. 2, the advertiser application 244 identifies advertisements and offers for indirect presentment, provides advertisements to customers 202.

In some embodiments, the advertiser application 244 may identify advertisements and/or offers for indirect presentment. In this way, the advertiser application 244 may determine which advertisements and offers have potential value for indirect presentation. The advertisements with potential value for indirect presentation may be determined based on market research, product data, advertiser data, or the like. In this way, the advertiser application 244 may identify one or more advertisements that may be more influential if they are provided indirectly to a customer. In some embodiments, advertiser application 244 may determine offers with potential value for indirect presentation. The offers may have degrees of value based on the degree assigned to the influencer. In this way, a zero degree influencer may receive a higher value offer based on his/her influence with a category of products. In some embodiments, the advertiser application 244 may provide the advertisements and/or offers to the influencer directly. The advertiser application 244 may present via online means or offline means based on the targeted influencer.

It is understood that the servers, systems, and devices described herein illustrate one embodiment of the invention. It is further understood that one or more of the servers, systems, and devices can be combined in other embodiments and still function in the same or similar way as the embodiments described herein.

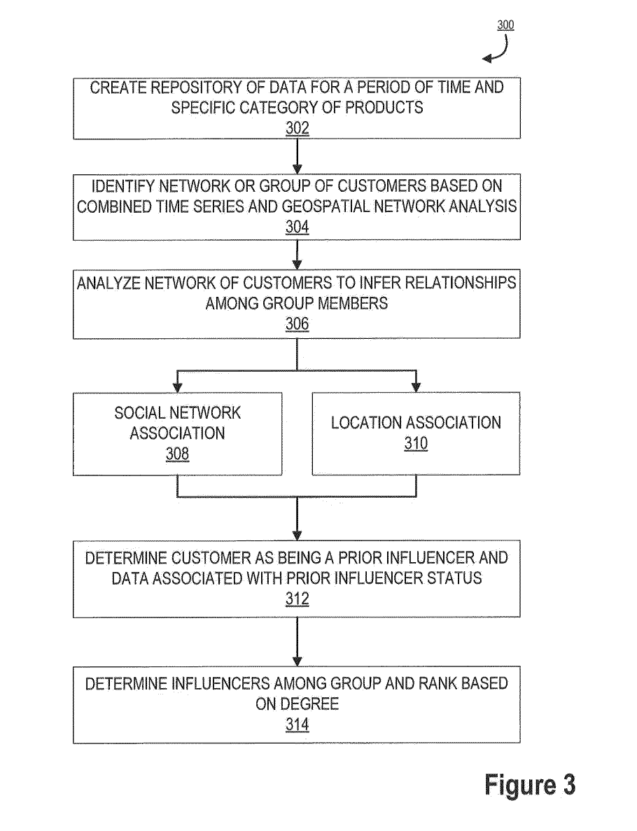

FIG. 3 illustrates a process map for identifying a group and an influencer associated with the group 300, in accordance with one embodiment of the present invention. In this way, the process 300 identifies a group of individuals that include an influencer and group around the influencer based on inferred relationship mapping. The group identified includes individuals that may be influenced indirectly by an influencer for a product category. In this way, the group of individuals may be more receptive to the advertisement or offer based on the influencer as opposed to the group receiving the advertisement directly. In this way, the invention provides a means of delivering advertisements and offers to appropriate influencers for diffusion throughout a group of individuals. The process 300 identifies groups and influencers within the groups for product categories within a given predetermined time frame.

The process 300 is initiated by first creating a repository of data for a period of time and specific category of products, as illustrated in block 302. In this way, a time frame is determined for the network diffusion convergence and divergence analysis. The time frame is a duration of time for a category of product purchase. The time frame may be a day, week, month, year, or the like. During the time frame, a group of individuals is identified as purchasing products within the category of products.

Next, as illustrated in block 304, the process 300 continues by identifying a group of customers based on combined time series and geospatial network analysis. In this way, the system identifies customers within the time frame and within a geospatial area for a specific product category. Thus, with the geospatial area defined, the system may further utilize the data for identifying or predicting inferred relationships between customers in the group. A group may include a social network, financial transaction network, financial transaction diffusion, coincident mapping or the like. The group may include individuals with common interests with respect to product categories. As such, the individuals within the network may all have an interest in a category of products, such as clothing, electronics, sporting goods, or the like.

The system may build the repository of data for the group of individuals within a geospatial area based on the product categories. As such, the system may identify groups of individuals that are linked together based on transaction history, coincident mapping, social networking, location, or the like. The network is grouped based on common interests in one or more product categories.

As such, for the time period and category of purchases, the system may identify a network of customers that correspond to the time period and category. The network may include more than one individual linked together based on similar transaction history, coincided mapping, or social networking. As such, a network of customers may be a group of individuals that are linked in some way, such that the network may all be interested in one or more of the same or similar products and services, and the advertisements associated with the products and services. In some embodiments, the network of customers may comprise one or more individuals that know each other. In other embodiments, the network of customers may not know each other. The network of customers may comprise more than one customer. The influencer being identified as the customer that may directly or indirectly influence the other individuals within the network or group with respect to purchasing products and/or services within a category. The group being identified as one or more customers that are directly or indirectly influenced by the influencer. In some embodiments, there may be one influencer in each network. In other embodiments, there may be more than one influencer in each network. In some embodiments, an individual may be an influencer for one category of products within a network, but be part of a group for another category of products within the network.

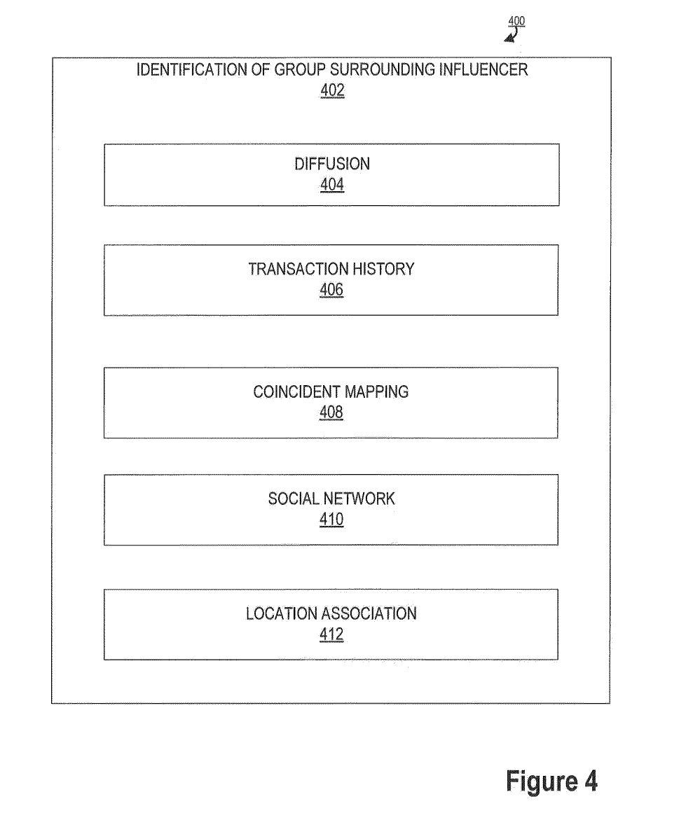

Next, as illustrated in block 306, the system may analyze a group of customers to infer relationships among group members. Both social network association 308 and location association 310 are utilized to infer relationships among the group members. Furthermore, the analyzing of the group to determine relationships among the group members is further illustrated in FIG. 4.

As such, once a group of customers and the purchase behavior of the group has been identified, an analysis of the group can be performed to identify and infer relationships among the members of the group. This allows the system to determine one or more customers within the group as key influencers of the population of the group. In this way, the system may identify influencers and categories of products or time frames that that particular influencer may be more influential to the group.

In some embodiments, the system may rely on social network association, as illustrated in block 308 to determine a group and influencers associated with the group. In yet other embodiments, the system may rely on location association, as illustrated in block 310 to determine the group and/or influencer associated with the group.

Next, as illustrated in block 312, the system determines if a customer in the group as being a prior influencer and, if so, the data associated with the prior influencer status. In this way, the system may determine the convergence time and divergence of the prior influencer to aid the system in determining the degree of the current influence.

Finally, as illustrated in block 314, the system may determine influencers among the group and rank the influencers based on degree for the product category. The key influencers are ranked and given a degree level based on the influence duration for that particular category. The influence may be based on social network, location, and/or the like further illustrated in FIG. 4. The degree level ranges from a 0 degree, or highest influencer, 1 degree, 2 degree, 3 degree, and the like descending in rank according to the number of individuals within the group that the influencer influences.

The influencer being identified as the customer that may directly or indirectly influence the other individuals within the network or group with respect to purchasing products and/or services within a category. In this way, the system may identify influencers and categories of products or time frames that that particular influencer may be more influential to the group. The influencers are ranked and accorded a degree based on potential influence of a group of individuals. The influencer is identified based on first identifying a product category and a time frame. In some embodiments, the influence ability of the influencer may be on the influencer's status and/or the number of individuals in a group. In some embodiments, an influencer's influence status may make him/her more likely to influence the members of the group for advertisement diffusion purposes. The influence status may increase if the influencer is a celebrity or it is determined that the influencer has significant influence over group members. In some embodiments, the number of individuals in the influencer's group may affect the influencers influence ability with respect to the group. The more individuals identified within the group, the more possibility for influence by the influencer in these circumstances.

For any given product category there may be one or more similarly positioned influencers, these influencers may be positioned into a group or cohort. The system will identify influencers that may diffuse ideas, concepts, and product advertisements or offers throughout a group based on his/her position as influencer within the network for that one or more product categories. The influencer being identified as the customer 202 that may directly or indirectly influence the other individuals within the network with respect to purchasing products and/or services within a category.

FIG. 4 illustrates a process map for a means of identifying a group and influencer within the group for a product category 400, in accordance with one embodiment of the present invention. As such, the means illustrated in FIG. 4 provide inference mapping for the system such that the system may determine one or more groups and/or influencers. In some embodiments, the process 400 provides a means for identifying a group surrounding an influencer 402. In yet other embodiments, the process 400 provides a means for identifying an influencer and the group.

As illustrated in section 404, one of the means of identifying group and/or, in some embodiments, an influencer within the group includes diffusion. Diffusion is a way of determining and identifying a rate of potential spreading of information through a group. Diffusion may utilize transaction history 406, coincident mapping 408, and/or social networking 410 to identify a group and/or influencer within the group.

As illustrated in block 406, one of the means of identifying a group includes transaction history review and identification. Based on product category and a predetermined time, the system may create a repository for customer spend. Because of the unique position of the financial institution providing the network diffusion system, the system may be able to identify and correlate various transactions of individuals. In this way, the system may correlate individuals with similar transaction histories into a same group. In this way, the system may identify similar transaction histories based on product category. The transaction history may also be matched based on similar merchant, product, geographic location, time, or the like associated with transactions. The system may generalize the transaction data and utilize it to develop a, group potentially associated with each other based on time and category of purchase.

As illustrated in block 408, coincident mapping may be one of the means of identifying a group and/or influencer within the group. Coincident mapping includes making locations using transaction history or the like of customers to identify a relationship between the customers. In this way, mapping may be able to identify a group of individuals or simply a random pattern of transactions and distinguish the same using coincident mapping algorithms. In this way, random transactions may be correlated to determine if the transactions are coincidental or may be part of a network or group.

Next, as illustrated in block 410, social network mapping may be one of the means of identifying a group and/or influencer within the group. In this way, the system may identify one or more individuals and the social network of friends, likes, followers, or the like associated with that individual. The social network associated with the individual may be interlinked with social networks of other individuals in order to create a group of individuals.

As illustrated in block 412, location association may be used to identify a group or influencer within the group. Location association may utilize various means such as transaction history, social networking, and/or the like to determine the geographic location of the customers within the group. In this way, the system may group together customers that have similar transactions in the past for a category of products within a specific geographical area.

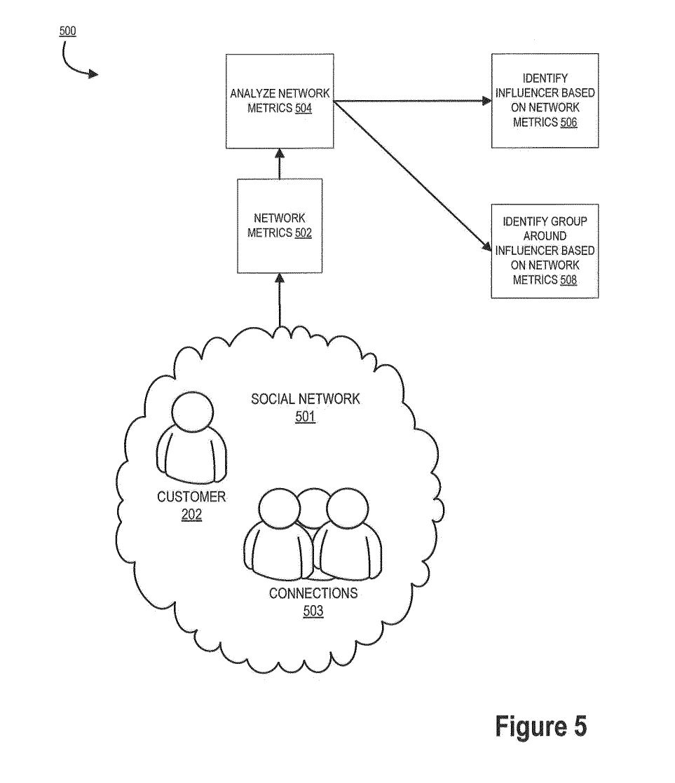

FIG. 5 provides a process map illustrating social network diffusion 500, in accordance with one embodiment of the present invention. The social network 501 includes the customer 202 and the customer connections 503 may be accessed by the system. In some embodiments, the customer 202 may be an identified influencer with an determined degree of influence associated therewith. In yet other embodiments, the customer 202 may be a group member associated with a product category. The customer connections 503 may be identified by the system as being a group around the customer 202 that has been identified as an influencer. The system may retrieve network metrics from the social network, in block 502. The network metrics may include network position within the network, posts, product information, connections, deepening value, and/or other data identifying an influencer or group individual and the products that the customer 202 may be interested in. As represented in block 504 the network metrics are analyzed by the system using a network science algorithm to determine the location of the customer 202 within the social network 501 based on product category. In this way, the system may identify a customer 202 as an influencer for one category of products and a group member for another category of product. The customer's posts, followers, links, or the like may all lead to a determination of the category of product for the network diffusion for advertisements. In some embodiments, once the system has retrieved and analyzed the network metrics the network metrics are used to identify a group or influencer based on the network metrics, as illustrated in block 506. In some embodiments, once the system has retrieved and analyzed the network metrics the network metrics are used to identify a group around an influencer based on the network metrics, as illustrated in block 508.

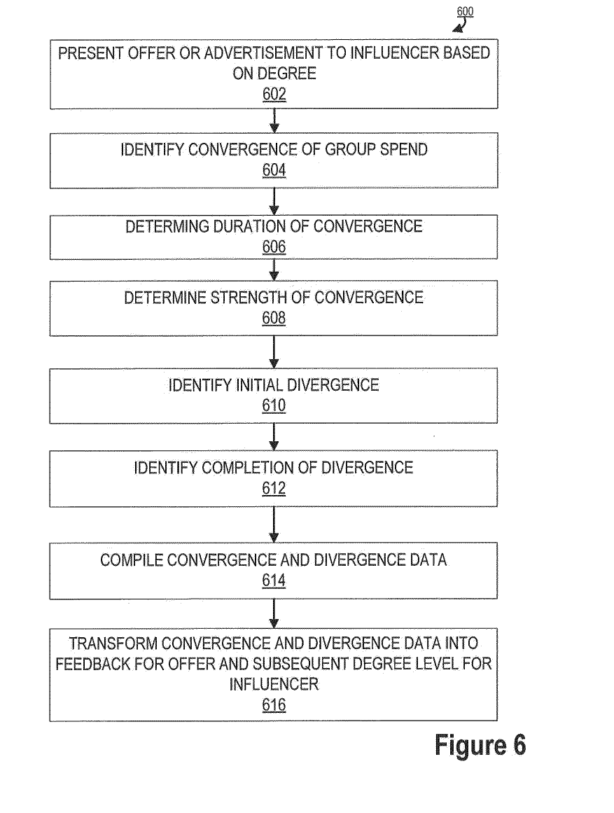

FIG. 6 illustrates a process map for convergence and divergence of spend data based on influencer degree 600, in accordance with one embodiment of the present invention. As illustrated in block 602, the process is initiated by presenting an offer or advertisement to an influencer, wherein the value of the offer or advertisement is based on the degree of influence established for the influencer.

Next, as illustrated in block 604, the process continues by identifying the convergence of spend patterns of customers within the influencer's group. In this way, the system determines a convergence of purchase behavior among the group surrounding the influencer based on the change in purchase habits of the influencer because of the offer provided to the influencer. As such, an advertisement or offer may be presented to the influencer, that offer may change the purchase habits of the influencer, such that the influencer may purchase a product of the offer or advertisement. Subsequently, there will be a convergence of purchase behavioral changes to the group influenced by the influencer. This convergence among the group will converge the purchase behavior of the group to a similar behavior as the influencer who received the offer. As such, the convergence may be such that the group may now also purchase the product of the offer or advertisement.

Once the convergence of the group is identified in block 604, the process 600 continues by determining a duration of the convergence, as illustrated in block 606. In this way, the system monitors and identifies the time the group spend converges towards the influencer's. The time frame may be days/weeks/months/years or the like.

Next, as illustrated in block 608, the process 600 continues by determining the strength of the convergence. The strength of the convergence is determined based on the time it took for the convergence to take place and the duration of the convergence. The faster the convergence occurred after the influencer received the greater the strength of the influence and the degree associate with the influencer. Furthermore, the longer the convergence, the more likely that the influencer has a greater influence over the group.

At some point the influence of the influencer will slowly wear off of the group. At that point, the group may return to their original purchase behavior. As illustrated in block 610, the initial divergence from the influencer's spend habits is identified for the group. In this way, this is when the initial members of the group start to revert back to their original spend patterns prior to the influencer's influence. Once the initial divergence occurs, the system stops the duration timing of the convergence and initiates a duration of divergence. Then, as illustrated in block 612, the system may identify the completion of the divergence. As such, determining the duration of the group's divergence away from the influencer. The divergence of influence back the groups original behavior may occur at various durations based on the influencer's influence on the group. As such, as stronger influencer will provide convergent purchase behavior of a group for a longer time than a weaker influence.

Next, as illustrated in block 614, the system may compile the convergence and divergence data determined. In this way the system may compile the time it took from presenting the offer to the first group member converging to the influencer, the duration of convergence of the group, the first time a group member subsequently diverged, and the duration it took to finally have complete diversion away from the influencer.

Once the convergence and divergence data is compiled, the system may then, as illustrated in block 616, transform the convergence and divergence data into feedback data for offers and/or advertisements as well as determinations for subsequent degree level data for influencers. As such, the quicker the convergence, the longer the convergence duration, and the longer the divergence duration, the more influential the influencer may be. However, the slower the convergence, the shorter the convergence duration, and the faster initial and complete divergence, the lower the influence of the influencer. In some embodiments, the data is utilized and transformed to provide offer and/or advertisement feedback for the system.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for convergence and divergence analysis, the system comprising:
a memory device with non-transitory computer-readable program code stored thereon;
a communication device;
a processing device operatively coupled to the memory device and the communication device within a distributive network for the convergence and divergence analysis, wherein the processing device is configured to execute the computer-readable program code to:
creating a repository of spend data for a predetermined period of time and for a specific product category;
identifying, using network data feeds from the distributive network, a group of individuals within the repository, wherein the group is identified based on each member of the group purchasing a product within the specific product category, within the predetermined period of time, and based on geospatial recognition;
inference mapping for identification of influencers among the group for the specific product category;
transforming, via the processing device, inference mapping data into degree ranking for influencer;
providing an offer to the influencer for a product within the specific product category, wherein the offer value is based on the degree ranking of the influencer;
identifying convergence of group spend data converging to influencer spend data based on the offer;
tracking and identifying divergence of group spend based on the convergence and record time data associated with divergence; and
transforming convergence data, divergence data, and recorded time data associated with divergence to advertisement diffusion feedback and influencer degree adjustments, whereby providing advertisement and offer effectiveness for the product category.

2. The system of claim 1, wherein the operation of identifying the group of individuals within the repository comprises using geographic location determination in connection with transaction history, coincident mapping, or social network mapping to identify the group of individuals geospatially located and associated with the specific product category, wherein transaction history identifies similar transactions for the specific product category, coincided mapping maps likely association of individuals based on the specific category of products, and social networking mapping identifies a network of individuals associated with each other.

3. The system of claim 1, wherein inference mapping for identification of influencers among the group for the specific product category further comprises inference mapping based on social network and geospatial data to identify and build degrees of influence among group individuals.

4. The system of claim 1, wherein identifying convergence of group spend data further comprises identifying when one or more individuals in the group purchase one or more products in the specific category of products that the influencer has purchased based on the offer.

5. The system of claim 1, wherein identifying convergence of group spend data further comprises tracking a duration of time associated with the convergence of group spend data.

6. The system of claim 1, wherein the operation of identifying divergence of group spend data further comprises determining an initial time point when one or more individuals of the group initially diverge in spend trends from the influencer back to the one or more individuals spend trend prior to being influenced.

7. The system of claim 1, wherein transform convergence data, divergence data, and recorded time data associated with divergence further comprises calculating an influence rate of the influencer based on the transform convergence data, divergence data, and recorded time data associated with divergence to adjust influencer degree for future groups and product categories.

8. A computer program product for convergence and divergence analysis, the computer program product, within a distributive network for the convergence and divergence analysis, comprising at least one non-transitory computer-readable medium having computer-readable program code portions embodied therein, the computer-readable program code portions comprising:
an executable portion configured for creating a repository of spend data for a predetermined period of time and for a specific product category;
an executable portion configured for identifying, using network data feeds from the distributive network, a group of individuals within the repository, wherein the group is identified based on each member of the group purchasing a product within the specific product category, within the predetermined period of time, and based on geospatial recognition;
an executable portion configured for inference mapping for identification of influencers among the group for the specific product category;
an executable portion configured for transforming inference mapping data into degree ranking for influencer;
an executable portion configured for providing an offer to the influencer for a product within the specific product category, wherein the offer value is based on the degree ranking of the influencer;
an executable portion configured for identifying convergence of group spend data converging to influencer spend data based on the offer;
an executable portion configured for tracking and identifying divergence of group spend based on the convergence and record time data associated with divergence; and
an executable portion configured for transforming convergence data, divergence data, and recorded time data associated with divergence to advertisement diffusion feedback and influencer degree adjustments, whereby providing advertisement and offer effectiveness for the product category.

9. The computer program product of claim 8, wherein the operation for identifying the group of individuals within the repository comprises using geographic location determination in connection with transaction history, coincident mapping, or social network mapping to identify the group of individuals geospatially located and associated with the specific product category, wherein transaction history identifies similar transactions for the specific product category, coincided mapping maps likely association of individuals based on the specific category of products, and social networking mapping identifies a network of individuals associated with each other.

10. The computer program product of claim 8, wherein inference mapping for identification of influencers among the group for the specific product category further comprises inference mapping based on social network and geospatial data to identify and build degrees of influence among group individuals.

11. The computer program product of claim 8, wherein identifying convergence of group spend data further comprises identifying when one or more individuals in the group purchase one or more products in the specific category of products that the influencer has purchased based on the offer.

12. The computer program product of claim 8, wherein identifying convergence of group spend data further comprises tracking a duration of time associated with the convergence of group spend data.

13. The computer program product of claim 8, wherein the operation of identifying divergence of group spend data further comprises determining an initial time point when one or more individuals of the group initially diverge in spend trends from the influencer back to the one or more individuals spend trend prior to being influenced.

14. The computer program product of claim 8, wherein transform convergence data, divergence data, and recorded time data associated with divergence further comprises calculating an influence rate of the influencer based on the transform convergence data, divergence data, and recorded time data associated with divergence to adjust influencer degree for future groups and product categories.

15. A computer-implemented method for convergence and divergence analysis, the method comprising:
providing a computing system within a distributive network for the convergence and divergence analysis, comprising a computer processing device and a non-transitory computer readable medium, where the computer readable medium comprises configured computer program instruction code, such that when said instruction code is operated by said computer processing device, said computer processing device performs the following operations:
creating a repository of spend data for a predetermined period of time and for a specific product category;
identifying, using network data feeds from the distributive network, a group of individuals within the repository, wherein the group is identified based on each member of the group purchasing a product within the specific product category, within the predetermined period of time, and based on geospatial recognition;
inference mapping for identification of influencers among the group for the specific product category;
transforming inference mapping data into degree ranking for influencer;
providing an offer to the influencer for a product within the specific product category, wherein the offer value is based on the degree ranking of the influencer;
identifying convergence of group spend data converging to influencer spend data based on the offer;
tracking and identifying divergence of group spend based on the convergence and record time data associated with divergence; and
transforming convergence data, divergence data, and recorded time data associated with divergence to advertisement diffusion feedback and influencer degree adjustments, whereby providing advertisement and offer effectiveness for the product category.

16. The computer implemented method of claim 15, wherein the operation of identifying the group of individuals within the repository comprises using geographic location determination in connection with transaction history, coincident mapping, or social network mapping to identify the group of individuals geospatially located and associated with the specific product category, wherein transaction history identifies similar transactions for the specific product category, coincided mapping maps likely association of individuals based on the specific category of products, and social networking mapping identifies a network of individuals associated with each other.

17. The computer implemented method of claim 15, wherein inference mapping for identification of influencers among the group for the specific product category further comprises inference mapping based on social network and geospatial data to identify and build degrees of influence among group individuals.

18. The computer implemented method of claim 15, wherein identifying convergence of group spend data further comprises identifying when one or more individuals in the group purchase one or more products in the specific category of products that the influencer has purchased based on the offer.

19. The computer implemented method of claim 15, wherein the operation of identifying divergence of group spend data further comprises determining an initial time point when one or more individuals of the group initially diverge in spend trends from the influencer back to the one or more individuals spend trend prior to being influenced.

20. The computer implemented method of claim 15, wherein transform convergence data, divergence data, and recorded time data associated with divergence further comprises calculating an influence rate of the influencer based on the transform convergence data, divergence data, and recorded time data associated with divergence to adjust influencer degree for future groups and product categories.
